(19) United States
(12) Patent Application Publication
(10) Pub. No.: US 2008/0074262 A1
(43) Pub. Date: Mar. 27, 2008

(54) Asset protection system and method

(76) Inventor: Michael B. Paulkovich, Severna Park, MD (US)

Correspondence Address: FOLEY AND LARDNER LLP;SUITE 500, 3000 K STREET NW, WASHINGTON, DC, 20007, US

(21) Appl. No.: 11/523,802

(22) Filed: Sep. 20, 2006

(51) Int. Cl. G08B 13/14; G08B 21/00

(52) U.S. Cl. 340/572.1; 340/686.6

(57) ABSTRACT

Described is a system and method for protecting against the accidental placing of precious or delicate assets within a hazardous device or area that could cause damage to the asset. A transponder tag is affixed to any precious asset that a user fears might enter a hazardous area. A detection apparatus, installed near the hazardous area, emits an alarm upon detecting that a transponder tag (and consequently the asset affixed to it) has neared the hazardous area. As a consequence, an item such as a cell phone, PDA, pager, portable media player, hearing aid, and any similar precious or delicate item that may accidentally be placed in an area hazardous to the item, such as a washing machine, swimming area, or area of radiation, will be detected by the invention, and the invention will respond with a warning alarm, notifying the user.

### CROSS-REFERENCE TO RELATED PATENT APPLICATIONS

### BACKGROUND OF THE INVENTION

1. Field of Endeavor

The present invention generally relates to systems and methods for detecting objects, and more particularly, to systems and methods for detecting objects fitted with simple miniature transponders that generate a signal responsive to reception of a signal transmitted thereto by a transceiver.

2. Background of the Invention

Two-way automatic detection devices that make use of radio frequency have been developed for many applications, such as identification of humans within secure areas, freight tracking, shoplifting detection, animal tracking, and so on.

Miniature apparatuses, and related technologies used for identifying tagged items (specifically, “RF tags”, often called “RFID tags”) are of interest to this new invention, used to protect precious assets against accidental damage. More specifically, the passive version of the RF tag is a most appropriate component for use in the present invention (such tag obtaining its operating power from an active detector's transmitted signal).

In shoplifting detection devices, for example, there normally exists a detector placed at store exits, whose purpose it is to detect merchandise items, such items being fitted with transponder devices (passive RF tags). A merchandise item's RF tag comprises transponder circuitry operative both to receive signals, and to generate a response signal. The detector comprises transceiver circuitry operative to generate a broadcast signal designated for reception by RF tags attached to items as they exit a retail store, and to detect the response signal from the RF tag affixed to the item. (The RF tag on an item responds to the broadcast signal transmitted by the detector with another signal, that other signal then being received by the detector.) The store personnel, or item manufacturers, attach RF tags to items or to the packaging of items, so that they will sound the alarm at the exit if the RF tag has not been deactivated. Deactivation of tags is normally done by sales clerks.

For instance, U.S. Pat. No. 3,500,373 to Minasy (March 1970), discloses a method specifically for preventing the unauthorized taking of articles of merchandise, by confining the exits of a retail store to limited paths. The merchandise articles are affixed with an RF tag. An electronic circuit in the tag reacts to an RF field transmitted around the store exits. Retail store proprietors are thus notified of the theft attempt when an article attached with a tag has moved through an exit.

Many other uses of RF tags have been disclosed.

U.S. Pat. No. 4,129,855 to Rodrian (December 1978) discloses a transponder-tag system for identifying and collecting data on farm animals.

German patent No. 2,826,861 to Weiner (May 1979) discloses a construction method for an anti-theft tag, having low material costs and low assembly costs, high electrical performance, and wherein such tag is largely resistant to tampering and unauthorized removal.

U.S. Pat. No. 4,990,891 to Reeb (February 1991) discloses another identification device for preventing theft of articles to which a transponder tag is affixed.

U.S. Pat. No. 5,517,188 to Carroll, et al. (May 1996) discloses an identification apparatus of the RF tag type that is programmable.

U.S. Pat. No. 5,519,381 to Marsh, et al. (May 1996) applies RF tag technology to the detection of multiple articles, and provides unique identification of each article, transmitting multiple independent signals, with a processor that can identify each transponder's signal individually.

U.S. Pat. No. 6,239,737 to Black (May 2001) discloses a method of attaching a transponder tag to an article using a plastic (or other non-ferrous) device, and a way of protecting the tag itself against tampering, removal, or damage, including countersinking the tag into the article.

U.S. Pat. No. 6,600,419 to Barritz (July 2003) discloses a method and system using RF tags attached to reading material, wherein the tags become deactivated when a person has opened the reading material, providing feedback to retailers regarding the reading of their mass-mailed catalogs.

U.S. Pat. No. 6,970,088 to Kovach (November 2005) discloses a method for tracking people and articles at an airport using RF tags.

U.S. Pat. No. 7,034,659 to Ungs (April 2006) discloses a method using RF tags to reduce theft of electronic devices, including a way to automatically disable the electronic device in the event it is taken, and software in the secured device that periodically confirms its geographic location.

U.S. Pat. No. 7,049,963 to Waterhouse, et al. (May 2006) discloses an identification and location system, using low frequencies, active transponders, and a complex method of locating tagged articles within a geographical space.

The aforementioned inventions, and other similar known inventions, strive to identify personnel; or to track multiple items within a monitored space; or to track and identify freight; or to track and collect data from animals; or to prevent theft; and so forth. Some related inventions are optimizations and improvements thereupon, or upon the manufacture or design thereof.

None of the aforementioned inventions discloses a system or method for detecting a precious asset as it approaches or passes through an area that is hazardous to that asset, for example, a system or method for detecting that a precious asset might approach and be susceptible to damage by a washing machine, swimming pool, or other area hazardous to an asset.

Accordingly, the new invention being disclosed is advantageous over the prior art, as it provides a system and method to detect an asset of value that encroaches an area (or region of susceptibility) that could cause damage to, or destruction of, the asset of value; and, a warning of this encroachment is thus supplied to the user as a way of protecting the asset from harm.

3. Objects and Advantages

Devices such as cell phones, PDAs, pagers, portable media players, wearable medical monitors, and similar miniature electronics typically are fairly expensive at the present time, and are quite easily placed in the wash by accident, most often by inadvertently leaving them in pockets of garments. Moreover, even if prices of such devices decline, the fact that valuable data within some such devices can be lost makes it very desirable to prevent their accidental washing (and loss of data), despite any low cost of the device itself.

More and more electronic items will be miniaturized in the near future, and they will find their ways into our pockets (and into our washing machines and other hazardous areas). Today, even many car keys have sensitive electronics embedded therein. Moreover, areas other than washing machines can also cause damage to sensitive items, such items being electronic or otherwise.

It is the prime object of this invention to detect a precious asset (the asset having attached to it an RF tag or similar transponder-type apparatus) that approaches or enters a hazardous area, and upon detection, to notify the user of the precious asset entering the hazardous area. The reader will appreciate that one can easily foresee a time in the near future when washing machines, for example, are manufactured wherein the detection device of this invention is included as standard equipment; and, precious assets such as cell phones, PDAs, and portable media players, are made with the counterpart transponder apparatus already installed on them, or within them.

Other precious and fragile items that merit benefit from the present invention are wallets, ID cards, checkbooks, small purses, and so forth, that may be susceptible to, for example, water.

Several objects and advantages of the present asset protection invention over prior art are:

(a) to provide a method and system for detecting a precious asset as it approaches or enters through a hazardous area, and to provide a warning thereof;

(b) to provide a simple and low cost method for users/lay-persons to tag the precious asset for protection;

(c) to provide a simple and low cost method for users/lay-persons to install the detection apparatus on or near a hazardous area, or to retrofit a device with the detection apparatus.

As will be shown, the resulting asset protection invention is thus able to detect and notify the user when any such tagged precious asset is placed in or near an area hazardous to the asset.

Further, as will be shown, a method and system is disclosed to allow a user to attach a transponder to a precious asset.

Further, as will be shown, a method and system is disclosed to allow a user to attach a detection apparatus to a hazardous area.

Although some descriptions herein contain certain specifics, these should not be construed as limiting the scope of the invention, but as merely providing illustrations of some of the presently preferred embodiments of this invention. For example, the text largely describes electronic devices with RF tags as protective transponders, and in some cases a washing machine as a hazardous area fitted with a detector; however, other types of devices could be fitted with protective transponders; and moreover, other areas or apparatuses could be considered hazardous or undesirable areas, and fitted with a detector.

Thus the scope of the invention should be determined by the claims and their legal equivalents, rather than by the examples given.

### SUMMARY OF THE INVENTION

In accordance with the present invention, described is a system and method for detecting that an asset has neared or entered a hazardous area that could cause damage to the asset.

The system includes a transponder such as an RF tag type transponder, attached to an asset; and a transceiving detection apparatus with a sensing element placed or focused near the hazardous area, wirelessly coupled to the transponder. The detection apparatus is configured to generate a signal via a transmitting element (for example, a broadcast antenna) whenever it is in an operational mode.

The detection apparatus transmits the signal in the region around the hazardous area (for example, the opening of a washing machine, or entrance zone to other such area that might be hazardous to the asset). The transponder on the asset receives the detection apparatus's signal, and generates a response signal. The response signal is received by the detection apparatus, and the detection apparatus emits appropriate warnings, preferably in the form of audible and visual alarms. A vibrating or otherwise tactile alarm is also appropriate, depending upon the user's needs, capabilities, and the environment wherein the present invention is deployed.

### BRIEF DESCRIPTION OF THE SEVERAL VIEWS OF THE DRAWING

To illustrate this asset protection invention, a preferred embodiment will be described herein with reference to the accompanying drawings.

FIG. 1 shows the preferred embodiment, the figure depicting a general topological block diagram of a user and the environment around a typical employment of the invention, including the movement of the transponder and asset toward a hazardous area, and a sensing element (a detector antenna).

FIG. 2 shows the preferred embodiment in more detail, depicting a block diagram of a detection apparatus and a transponder, including all major electronic components of the preferred embodiment of the invention.

FIG. 3 shows a preferred embodiment as applied to a particular use and benefit, the detection apparatus configured to detect and notify the user that a tagged precious asset has approached the opening of a washing machine.

FIG. 4 shows components of a self-adhesive embodiment of the transponder.

FIG. 5 shows a self-adhesive, integrated, enclosed embodiment of the detection apparatus.

### DRAWINGS—REFERENCE NUMERALS

10 precious asset
15 detector antenna
20 transponder
25 detection apparatus
30 detector
31 detector power source
32 audible annunciator
33 visual annunciator
34 detector-generated signal
35 transponder-generated signal
40 hazardous area
50 directional movement arrow
60 user
70 antenna wire
80 power wire
90 washing machine
95 washing machine lid
100 washing machine opening
110 transponder adhesive
120 protective backing
130 detector enclosure
140 attachment plate
200 pattern recognition circuitry
201 interface
202 processor
203 database storage medium
320 audible annunciator wire
330 visual annunciator wire

### DETAILED DESCRIPTION OF THE PREFERRED EMBODIMENTS

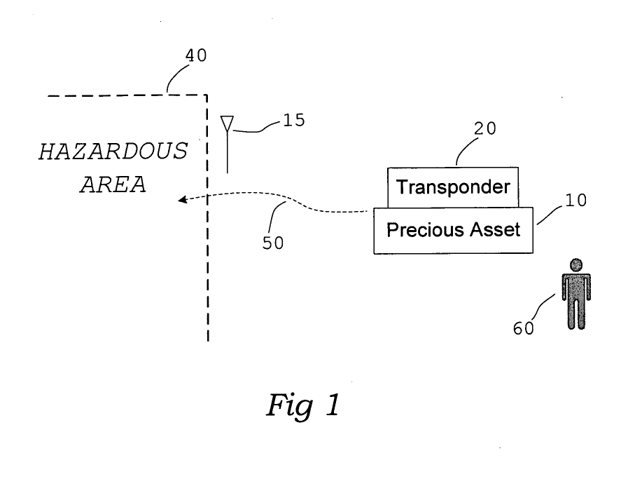

The existence of seemingly benign (but potentially hazardous) areas, and the desire to protect assets from such hazardous areas, are the essential inspirations and driving elements for the conception, design, and methods of the present invention. As such, referring now to the drawings, and more particularly to FIG. 1, there is shown a block diagram of a preferred embodiment of the invention, the drawing indicating a precious asset 10, affixed to a transponder 20. In the figure, a detector antenna 15 acts as both sensing element and transmission element, and is located near or focused around a predetermined hazardous area 40 (such as a washing machine or swimming pool), such hazardous area which may cause damage to the precious asset. Also shown therein is a user 60, such user being a person, entity, or mechanism, physically and connectively involved in the process of moving the asset 10 (and consequently also moving the attached transponder), which asset may be moved by the user toward or into the hazardous area as shown by a directional movement arrow 50, indicative of such movement.

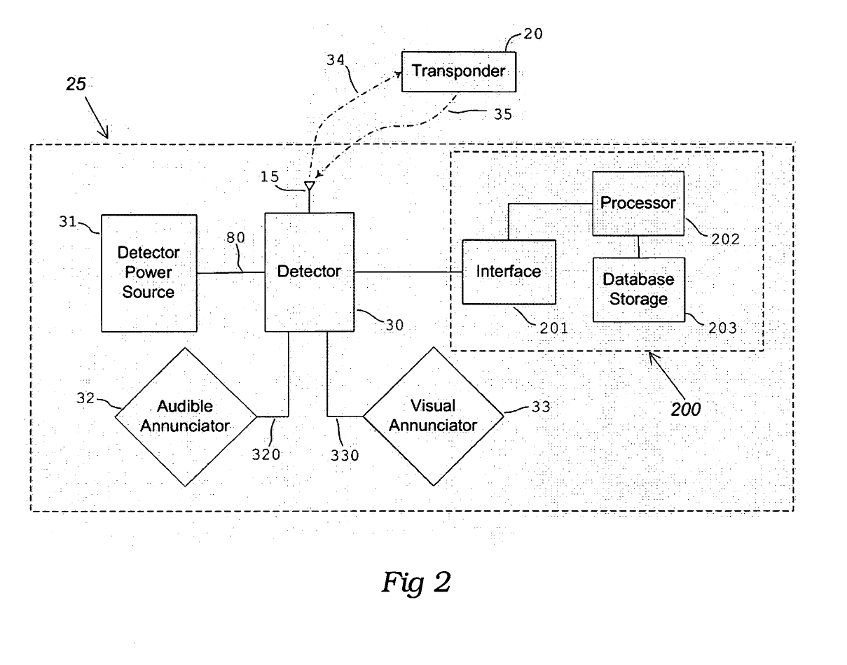

Referring now to FIG. 2, there is shown a block diagram of the preferred embodiment of the invention. Whereas FIG. 1 has illustrated the overall nature of the topology, dynamics, transponder, hazardous area, and general asset detection issues that are of prime concern to the present invention, FIG. 2 now presents a detailed block diagram of the major electronic subcomponents that comprise the invention, and their interconnection.

A detection apparatus 25 is introduced in this drawing, comprising several subcomponents to be introduced below, and having the aforementioned detector antenna 15 in electronic communication with a detector 30.

The detector antenna is placed within (or, has its transceiving capabilities directed around) the hazardous area (the hazardous area having been illustrated in FIG. 1). Thus, the detector antenna, wherever so placed, is arranged to broadcast a detector-generated signal 34 around the hazardous area, and, to detect a transponder-generated signal 35 from the transponder, when the transponder enters the broadcast region (that region also generally being the hazardous area).

Electrical power to the detection apparatus is provided by a detector power source 31, being electrically connected to the detector via a power wire 80. The detector power source may be of any type appropriate to the detector electronics, to the situational logistics, and to constraints of the environment. Batteries, AC “wall” power, solar, or some other power source may be appropriate as the situation dictates, and this is a design consideration for those who are skilled in the art, and who are knowledgeable about the environmental constraints of the particular application.

Most often the detection apparatus should be kept in the operational mode and powered on, especially in configurations of the invention wherein the selected power source for the detection apparatus is essentially unlimited (such as AC or solar). But, power-saving schemes may be employed to supply power to the detection apparatus only when it is observed that the area is being used, for instance by using motion detectors.

The detector-generated signal that is broadcast to the region around the hazardous area results in the following effects:
if any tagged asset is placed within the broadcast region and range of the detector-generated signal, the transponder attached to the tagged asset receives the signal 34;
the transponder, upon receipt of the signal 34, generates a response, that being the transponder-generated signal 35;
the transponder-generated signal 35 is then received by the detector antenna 15.

The transponder-generated signal received by the detector antenna causes the detector to activate an audible annunciator 32 (attached electronically to the detector by an audible annunciator wire 320), and to activate a visual annunciator 33 (attached electronically to the detector by a visual annunciator wire 330), and thereby notifying the user of some precious asset that is encroaching on an area that may cause damage to the asset. This preferred embodiment includes both visual and audible annunciators, to accommodate users who might be hearing impaired, or visually impaired; although, embodiments with fewer annunciators do not depart from the spirit and scope of the present invention.

The use of the annunciator wires 320 and 330 in this drawing assumes direct electrical connection; however, other embodiments may communicate wirelessly between the detector and the annunciators.

As will be appreciated by those skilled in the art, the location of the detector's sensing element(s) (namely, in the example shown, the detector antenna 15) clearly must be focused toward, or positioned near the hazardous area; but the locations of other subcomponents associated with the detector (for example, power source and detector electronics) are largely inconsequential. Moreover, the antenna arrangement may be chosen to be a single bi-directional transceiving antenna, or a separate transmitting antenna and receiving antenna, or combinations and/or arrays of antennas, depending upon the type of electronics used for the detection apparatus, considerations regarding the hazardous area, and other design factors, without departing from the spirit and scope of the present invention. Those of ordinary skill will recognize the communication between the transponder and detector can occur using well known techniques. By way of example and not limitation, such communication can take place between a transmitter and a receiver on each device tuned to transmitting and receiving frequencies, or by resonantly or magnetically coupling the transponder and detector and employing load modulation techniques.

An alternative embodiment recognizes that many assets one seeks to protect are made of metals. This alternative embodiment replaces the detector 30 with a metal detector. Use of a metal detector eliminates the need for a transponder, since all metallic devices will be detected and trigger a response. Such a simplified embodiment could be subject to false alarms, for example as may be triggered by metal buttons, zippers or other metallic components on clothing placed into a washer. Such false alarms would not be an issue where transponders are used.

Another feature according to the invention equips detection apparatus 25 with a recognition feature, thereby augmenting the detection apparatus to be able to distinguish between assets which require protection and those which do not. This approach would also reduce the potential for false alarms. For example, implementing a recognition feature permits a detection apparatus on a clothes washer to distinguish between metallic buttons or zippers, which should not trigger an alarm, and portable electronic devices such as cell phones, PDAs, media players and medical monitors, which require protection and should trigger an alarm. Such a recognition feature can be implemented using a metal detector, magnetic anomaly detector or active radio transmitter which generates a signal, and receives magnetic or electromagnetic signatures or images that are compared to those stored in a database accessible to the detection apparatus 25 for recognition purposes. Pattern recognition techniques currently used in facial recognition and bomb detection applications could be employed as part of the present invention to distinguish precious assets which would be damaged by crossing into areas that would be hazardous to them. In one exemplary implementation, as shown in FIG. 2, pattern recognition circuitry 200 includes an interface 201, designed to be compatible with the type of signal output by detector 30, to condition signals between the detector and pattern recognition circuitry 200. Processor 202 receives conditioned signal information from the interface circuitry and is programmed to develop a representation of the detected item. Processor 202 compares some or all of the representation developed for the detected item with signature information for various items stored in database storage medium 203. Those of ordinary skill will recognize that signature information stored in database storage medium 203 can be configured as fixed or reprogrammable and that the database storage medium 203 or pattern recognition circuitry 202 can be a part of the detection apparatus 25 or can be one or more separate units communicating with the detection apparatus 25. Based on its comparison of the received conditioned signals with the stored signature information, pattern recognition circuitry 200 discriminates assets which would be harmed by encroaching upon the detected area and sends a signal to activate annunciators 320 or 330 either directly or through detector 30.

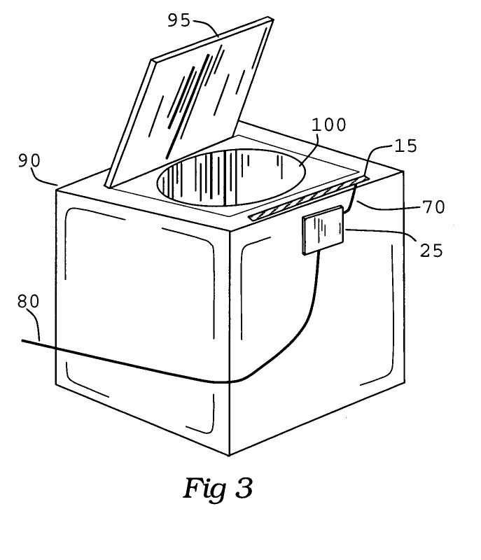

Referring now to FIG. 3, there is shown a particular application of a preferred embodiment of the present invention, arranged and applied to the problem of protecting the precious asset against accidental placement into a particular hazardous area, that being a washing machine 90. The detector antenna 15 is affixed near a washing machine opening 100 for the detection of tagged items that might be placed therein. The mounting position of the detector antenna is chosen so that it is not in conflict with motion or closing of a washing machine lid 95, and also so that is in the general path of items being placed into the washing machine. Moreover, as RF signals are used, the detector antenna is mounted such that it is electrically insulated from the metal washing machine (thus not grounded thereto). The configuration shown in the drawing requires an antenna wire 70, to connect electrically the detector antenna 15 to the detection apparatus 25, so that the detection apparatus may be positioned at a location different from the detector antenna.

The use of the antenna wire in this drawing assumes direct electrical connection; however, other embodiments may communicate wirelessly between the detector antenna and the detector.

The detector power source (referred to previously as 31) comprises, in the application shown in FIG. 3, the power wire 80 connected proximally to, and supplying power to the detector, and connected at the distal end to a standard AC power outlet via standard AC plug (AC plug and power outlet are not shown in the drawing).

Several previously introduced components, such as the transponder, the precious asset, and the annunciators, are not shown in the drawing, as their interoperation and uses have been described in sufficient detail above. As will be shown in another preferred embodiment, major components of the detection apparatus 25 that were shown in FIG. 2, namely, the detector, the detector antenna, the audible annunciator, and the visual annunciator, may be combined into one integrated unit.

Annunciators connected electronically to the detector should be placed at strategic locations in the area around the washing machine where appropriate to notify the user of the encroachment of the asset upon the hazardous area.

The location of the detection apparatus 25, shown in the drawing as being mounted at the front of the washing machine, is generally not of consequence, as long as the detector is electronically connected to the appropriately mounted detector antenna 15, and is connected to the detector power source; and as long as the annunciators are placed to effectively radiate their announcement signals (e.g., sounds and lights) to the user.

If the detector antenna is arranged such that annunciators are activated after a tagged asset has already been placed into washing machine, then user instructions should warn the user not to start the water running until all garments have been placed therein. If, on the other hand, the arrangement is such that tagged assets will activate the annunciators when they simply near the washing machine, such warning may not strictly be necessary, depending upon the arrangement chosen, and the particular embodiment of the invention.

Alternate modulations of the warning signals as a function of the strength of the transponder-generated signal 35 are appropriate in the present invention. By way of example, referring again to FIG. 2, the audible annunciator 32 may generate a varying pulsing tone, using widely-spaced pulsing tones when the transponder-generated signal 35 is weak, and faster pulses as the signal intensifies. Similarly, the visual annunciator 33 may transmit a red light, then yellow, then white, as transponder-generated signal 35 intensifies. This optional design requires proper detector sensitivity and antenna directional considerations. This option aids the user by notifying that there are tagged assets that approach the washing machine (for example, somewhere in a laundry basket or hamper); and then it helps the user to determine which article of clothing may contain the asset, as the user can take each article individually, and move it toward the washing machine, paying attention to annunciator signals.

A human user of the washing machine may have other tagged assets in their pocket while using the washing machine. A simple cautionary note to users is appropriate, warning the user to remove any other tagged assets from the user's person before loading the washing machine; and that otherwise, the user may receive false alarms. Such a requirement upon the user is clearly reasonable in everyday use of this and other embodiments of the present invention. On the other hand, it may be preferable to configure the arrangement and the directionality of the detector antenna(s) such that a user need not remove other tagged assets from the user's person. Such an embodiment should not strive only to ensure that tagged assets properly trigger the annunciators; but also, testing should be done by a test personnel who has other tagged assets on his/her person; for example, one in a shirt pocket and another in a pants pocket. Such testing should strive to optimize the final design of that embodiment of the invention to minimize false alarms. Adjustment of the directionality of the detector sensing element(s), and the sensitivity of the detector, are considerations well understood by those skilled in the art and regarding such test procedures and customization. Such a design that minimizes false alarms is an option in the present invention.

In this particular application of the present invention, a washing machine is considered as the hazardous area to the assets. As a way of clearly describing the various components of the detector subsystem of the invention, the text largely has described each component separately in detail, along with general positioning guidelines of each component. These guidelines provide detailed descriptions both to the benefit of the case where the washing machine is obtained by the user without the detection apparatus already having been installed thereupon, and of the case where a manufacturer should install the detection apparatus on washing machines that are subsequently made available for sale.

It is in fact advantageous and preferred that washing machine manufacturers provide their washing machines with all subcomponents of the detection apparatus provided as standard equipment; and that, as such (since the user in such case will not need to install a detection apparatus), the detector antenna(s) be positioned by the manufacturers optimally, for example, such that false alarms are minimized, the positioning being such that the detection of signals from the transponder are directionally shielded, for instance, by ferrous material. To achieve this, the detector antenna (or a receiving element thereof) is preferably located behind a metal shield, and enclosed in a plastic waterproof sleeve; and more particularly, preferably is installed inside the metal washing machine opening, the metal washing machine thus providing the signal shielding. The detector thus is less likely to trigger a false alarm when a tagged item is in the pocket of the user loading the washing machine. Similar shielding and directionality considerations apply to the antenna that transmits signals from the detector, if separate antennas are used.

The RF frequency and/or modulation of the signals 34 and 35 should be chosen so as not to interfere with typical household wireless devices such as wireless phones and modems.

The RF frequency and/or modulation of the transponder-generated signal 35 clearly should be chosen to be different from those used to detect shoplifting, so as not to activate security alarms when the user enters a retail store with an asset (such as a user's cell phone) that has been tagged for protection by the present invention. Verification that a tagged asset does not activate standard store theft alarms should be a part of the testing of prototypes and embodiments of the invention.

It is also advantageous and preferred that laundry basket and hamper manufacturers provide their items with all subcomponents of the detection apparatus provided as standard equipment, thus warning the user of the presence of a precious asset well before it might be accidentally tossed into a washing machine full of water. By way of example, a typical “portable” laundry basket would preferably use battery power, whereas a stationary stand-up hamper would likely benefit from using A/C power.

Another configuration according to the invention includes a detector apparatus which can be attached to a washer, hamper, laundry basket, or other object where the detection of precious assets is desirable.

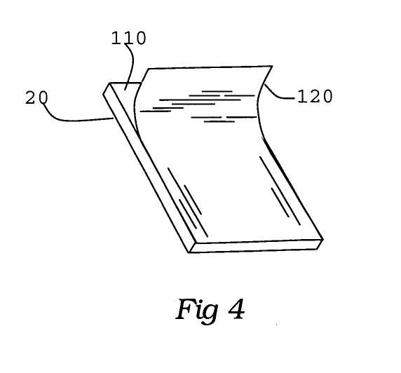

For adaptation of any precious asset that a user wishes to protect in accordance with the present invention, a system and method of user attachment of the transponder to the precious asset is straightforward, and is disclosed herein. Referring now to FIG. 4, there is shown a drawing depicting a self-adhesive embodiment of the transponder subcomponent of the invention. In this particular transponder embodiment, the transponder 20 has affixed to it a transponder adhesive 110, attached to the surface of the transponder, the intent of which is to affix the transponder adhesively to a precious asset of choice. The transponder adhesive is protected by a standard “peel-off” cover method of prior art, comprising a protective backing 120, shown in the figure partially protecting the transponder adhesive 110, the figure depicting the protective backing slightly peeled away from the transponder. A user wishing to affix the transponder to any of the user's assets must peel the protective backing away, thus exposing the transponder adhesive. The user then presses the side of the transponder that has the transponder adhesive to an appropriate surface on the asset to be protected, thus affixing thereto.

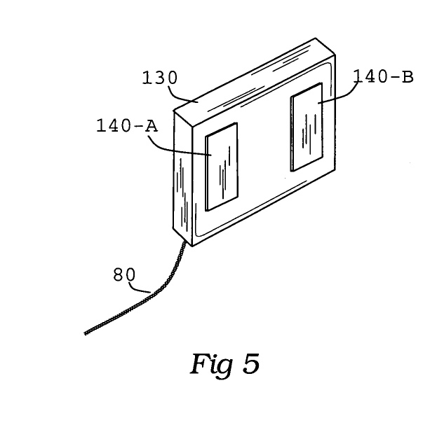

For adaptation of a hazardous area (such as a washing machine) that a user wishes to retrofit for use with the present invention, a preferred embodiment comprises the detection apparatus, wherein the related detector components are integrated and enclosed, and a method is disclosed herein for attachment of the detection apparatus to a surface near the hazardous area. Referring now to FIG. 5, there is shown a drawing depicting a self-adhesive embodiment of the detection apparatus of the invention. In this particular embodiment of the detection apparatus, the components of the detection apparatus are integrated and enclosed within a detector enclosure 130, such detector enclosure comprising: the detector, detector antenna, annunciators, and appropriate connection wires. These components of the detector have been previously described, and as such are not shown in the drawing; in the drawing they are enclosed and integrated within the detector enclosure 130.

Clearly, annunciators mounted within the detector enclosure need pathways for their announcement signals; by way of example, holes or perforations for audible annunciators, and line-of-sight optical paths to the user from visual annunciators. This integrated embodiment can be designed with the annunciators on the outside of the detector enclosure, without departing from the spirit and scope of the present invention.

The portion of the detector enclosure that houses the detector antenna(s) must be constructed of material that will not interfere with the RF signals, preferably being plastic.

The detector power source (referred to previously as 31) comprises, as described in a previous embodiment wherein AC wall power was employed, the power wire 80, connected to the AC outlet (outlet is not shown in the drawing) and supplying power to the detection apparatus. Electronic components of the detection apparatus preferably are designed for DC power; for this case, a standard off-the-shelf power conversion device (for example, a transformer and related filtering components) is also used, not shown in the drawings.

An attachment plate 140, secured to the outside of the detector enclosure, is used to affix the detection apparatus to the washing machine, or to a surface near any hazardous area. The figure shows two attachment plates, 140-A and 140-B; various design factors would dictate the number of, and placement of, the attachment plate or plates on the detector enclosure.

The configuration shown in the figure, having the integrated detection apparatus residing within the enclosure, and the attachment plate(s) outside, illustrates the essential elements of the aforementioned self-adhesive embodiment of the detection apparatus. For the case of a washing machine, the attachment plates are preferably magnetic plates. In this case, the user simply secures the integrated detection apparatus against the washing machine (which in this case clearly must be ferrous), with the magnetic attachment plates facing the washing machine. The detection apparatus is thus magnetically secured thereto, and ready for use.

When magnets are used as the attachment plates, they must be located so as not to interfere with RF signals between the detector antenna and the transponder.

Other appropriate selections for the attachment plate subcomponent are: a self-adhesive, covered by a peel-off backing; water-activated adhesives; epoxies; a clip-on or clamping method; and Velcro (one portion being adhesively affixed to the washing machine, and its counterpart acting as the attachment plate, being adhesively affixed to the outside of the enclosure).

The user may elect to attach the detection apparatus to appropriate surfaces that are not on the washing machine, but are near the opening, such as walls, shelves, or ceiling thereabouts, maintaining consideration regarding RF line-of-sight as previously mentioned, and appropriate placement of annunciators. As these surfaces are not likely to be ferrous, any preferred embodiment of the present invention should provide the user with several methods of attachment and attachment instructions, allowing the user to select the appropriate method.

In the case of a top-loading washing machine, the user-placement of the detection apparatus on the washing machine is preferably on or near the top, but not on the washing machine lid (which, when opened, and if ferrous, interferes with the RF signals). Similarly, the washing machine control panels are often positioned on the top side, at the rear, and user-placement of the detection apparatus there, while seemingly convenient, might interfere with RF. The user should be cautioned via user instructions against placing the detection apparatus on an area where RF signals will be blocked when the lid is open.

In the case of a front-loading washing machine, the user-placement of the detection apparatus on the washing machine is preferably on or near the front, but not on the washing machine lid/hatch. If there is insufficient space or other reasons why the detection apparatus can't be placed on the front, then placement on the washing machine top, and very near the front, is advised.

Installation of the integrated detection apparatus using the aforementioned method for use around hazardous devices or areas other than washing machines requires similar procedures, chosen depending upon the device or area; and thus, may include the general methods and components described above, as applicable. For example, the detection apparatus may be mounted on a hot tub, or at the entrance to a hot tub area. Also, detection apparatuses of this nature may similarly be mounted at the perimeters of a swimming pool, near a microwave oven, on a hamper or laundry basket, on a laundry chute, and other areas hazardous to precious assets, or precursor areas thereof.

### Operation

The manner of using this asset protection invention is as follows:

The user who wishes to protect assets from damage by a hazardous area should affix a transponder tag to each asset that is in need of protection. The detector is to be mounted near the hazardous area, the detector antenna being located such that it has RF line-of-sight access to the hazardous area.

Power to the detector should be always applied whenever protection of assets is desired. The user, in everyday use of the hazardous area, and in use of the assets to be protected, should take notice whenever an alarm (the visual, audible, or other annunciator) activates, and should then find the asset that has triggered the alarm, and remove it before damage is caused by the hazardous area, such alarm benefiting the user by virtue of the design and operation of the present invention.

### CONCLUSION, RAMIFICATIONS, AND SCOPE

Accordingly, the reader will see that the invention disclosed provides beneficial notification to users when a tagged precious asset approaches or passes through a hazardous area, thus protecting the asset, to the benefit of the asset, and to the benefit of the user.

Some descriptions of preferred embodiments mention a transponder that has been affixed to the precious asset by the user. However, the reader can appreciate that other embodiments are envisioned, wherein certain precious assets are manufactured and provided with a transponder pre-attached, being suited to hazardous areas (or appliances) that are manufactured and distributed with pre-attached detection apparatuses that are compatible and interoperable with the precious asset transponders. By way of example, washing machines may be manufactured and distributed with a certain type of detection apparatus; and cell phones, PDAs, pagers, portable media players, and similar miniature electronics may be manufactured and distributed already fitted with transponders that are compatible with that certain type of detection apparatus included with those washing machines. The reader also will appreciate that an industry standard easily can be foreseen, being beneficial to society, such standard governing the transmission frequencies, modulations, and/or protocols to realize and optimize the embodiments, scenarios, and applications involving the present invention.

Security areas, and detection of unwanted devices, may come to mind with regard to prior art and the present invention. Concerning this, the intentions and uses of the present invention are essentially the opposite of such security areas, like court houses and airports, wherein the owners of those secure or protected areas wish to install an apparatus to detect items that they consider unwanted in the area, before such an item enters that area (e.g. recorders, cameras, guns, bombs, knives, and so forth). By way of example, it would not benefit airports to try to detect weapons that have been affixed with RF tags by the owner of such weapons (a perpetrator trying to sneak a weapon through such area would simply not affix such a tag; or, if such tag is already attached, the perpetrator would remove it). In the use and application of the present invention, it is in fact of interest to the owner of an asset, who wishes the asset to be protected, to affix a tag.

Clearly it is thus of benefit to such a user to affix a transponder to precious assets, and moreover, it may well also be of interest and benefit to the manufacturer of certain types of items to provide detection of tagged assets, built-in to the manufacturer's item, this being a selling-point for the manufacturer's product.

By way of more examples of application of the present invention: in a society where it may be that precious assets such as cell phones and other items are indeed already fitted with “standardized” transponders for the stated purpose of this asset protection invention, special areas like swimming pools, spas, and hot tubs, may be fitted with detection apparatuses of the type disclosed herein, as a courtesy to users who may approach the special area with a (tagged) precious asset on their person. Applications such as this underscore the variety of assets that might be considered precious and in need of protection; this includes shoes, delicate clothing, wrist-watches, pill boxes, notepads, ID papers, checkbooks, and other delicate or precious personal effects that may be damaged or destroyed by (in this example) water.

Another particular application of the present invention involves warning wearers of pacemakers when they approach a device dangerous to the pacemaker. Such devices include microwave ovens, radar systems, high-power radios, and the like. Devices such as these can generate electronic interference that affects the tiny electronic circuits of a pacemaker, causing malfunction. If a standard program were to exist, wherein manufacturers of those dangerous devices might build them with the detection apparatus already installed, external pacemakers should also be built with the RF tag that is interoperable with the detection apparatus placed on them. A person with an internal pacemaker should always wear an RF tag.

While the above description contains many specificities, these should not be construed as limitations on the scope of the invention, but rather as an exemplification of preferred embodiments thereof. Many other variations are possible. For example, the above description largely mentions passive RF tags as the transponder affixed to the asset to be protected, but embodiments may use other types of transponders that would interoperate with the detector chosen for any embodiment. As another example, the detector's sensing element for detecting the response signal from the transponder has been described as an antenna. The term “antenna” has been used generically herein to indicate any signal sensing element (and/or transmission element) appropriate for reception (and/or transmission) of a signal. Also, the text has largely described “RF” as the transmission medium for interconnection of transponder to detector; other mediums such as ultrasonics do not depart from the spirit and scope of the present invention. Accordingly, the scope of the invention should be determined not solely by the embodiments illustrated, but by the appended claims and their legal equivalents.

What is claimed is:

1. A protection system for detecting and announcing the presence of an asset that encroaches upon a hazardous space, said protection system comprising a transponder affixed to said asset, at least one detection apparatus, and at least one annunciator, wherein:
said at least one detection apparatus generates a first signal designated for reception by said transponder, said transponder reacting to said first signal by transmitting a second signal, said second signal being received by said at least one detection apparatus; and
said at least one detection apparatus is configured to detect said second signal when said transponder encroaches upon said hazardous space, said at least one detection apparatus consequently activating said at least one annunciator; and
said at least one detection apparatus and said transponder are wirelessly communicatively connected,
whereby the detection apparatus provides a detecting of the asset, being affixed with the transponder, as the asset enters the hazardous space.

2. The protection system recited in claim 1, wherein said first signal is directed locally around said hazardous space.

3. The protection system recited in claim 1, wherein said at least one detection apparatus is configured with at least one transmitting element to broadcast said first signal.

4. The protection system recited in claim 1, wherein said at least one detection apparatus is configured with at least one sensing element to detect said second signal.

5. The protection system recited in claim 1, wherein said at least one transmitting element and said at least one sensing element comprises one bi-directional transceiving element, whereby said bi-directional transceiving element is used for both signal transmitting and signal sensing.

6. The protection system recited in claim 1, wherein said transponder is of the passive type.

7. The protection system recited in claim 1, wherein said transponder is of the active type.

8. The protection system recited in claim 1, wherein said at least one annunciator comprises at least one of:
an audible annunciator;
a visual annunciator;
a tactile annunciator.

9. The protection system recited in claim 1, wherein said at least one annunciator emits at least one warning signal, whereby a user is notified of the detecting of the asset as the asset enters the hazardous area.

10. The protection system recited in claim 1, wherein said at least one annunciator emits at least two different warning signals, selection thereof being a function of the received strength of said second signal.

11. The protection system recited in claim 1, wherein said at least one detection apparatus comprises: at least one detector; at least one detector power source; at least one annunciator; at least one transmitting element; and at least one sensing element.

12. The protection system recited in claim 1, wherein said hazardous space is a washing machine area.

13. The protection system recited in claim 1, wherein said hazardous space is a swimming area.

14. The protection system recited in claim 1, wherein said hazardous space is a spa area.

15. The protection system recited in claim 1, wherein said hazardous space is a hot tub area.

16. The protection system recited in claim 1, wherein said hazardous space is an RF-emitting area.

17. The protection system recited in claim 1, wherein said hazardous space is an RF-emitting area that is hazardous to a pacemaker.

18. The protection system recited in claim 1, further comprising an attachment method for affixing said transponder to said asset, whereby the user can adapt said asset for detection by said protection system.

19. The protection system recited in claim 1, further comprising an attachment method for affixing said at least one detection apparatus to a surface near said hazardous space, whereby said user can adapt said hazardous space for integral use in said protection system.

20. The protection system recited in claim 19, wherein said attachment method comprises at least one attachment clip.

21. The protection system recited in claim 19, wherein said attachment method comprises at least one attachment clamp.

22. The protection system recited in claim 19, wherein said attachment method comprises a magnetic method.

23. The protection system recited in claim 19, wherein said attachment method comprises a dry adhesive method.

24. The protection system recited in claim 19, wherein said attachment method comprises a water-activated adhesive method

25. The protection system recited in claim 19, wherein said attachment method comprises an epoxy method.

26. The protection system recited in claim 19, wherein said attachment method comprises a Velcro method.

27. A detection apparatus for use in a system announcing the presence of an asset which encroaches upon a space hazardous to said asset, comprising:
a detector for generating a first signal in the presence of a transponder affixed to said asset, said transponder responding to said detector in a manner detectable by said detector;
circuitry for generating an alarm signal if said asset encroaches upon said hazardous space;
an annunciator responsive to said alarm signal.

28. A detection apparatus for use in a system announcing an asset having a predetermined material therein encroaching upon a space hazardous to said asset, comprising:
a detector for detecting the presence of said predetermined material in said asset;
circuitry for generating an alarm signal if said asset encroaches upon said hazardous space;
an annunciator responsive to said alarm signal.

29. The protection system recited in claim 1, comprising recognition circuitry, wherein said recognition circuitry compares signals from a detector in said detection apparatus to signature information stored in a database.

30. The protection system recited in claim 29 wherein said recognition circuitry distinguishes between a said asset requiring protection and other items not requiring protection.

31. The protection system recited in claim 29, said recognition circuitry comprising a processor and a database storage medium accessible to said processor.

32. The detection apparatus recited in claim 27 comprising recognition circuitry, wherein said recognition circuitry compares signals from said detector to signature information.

33. The detection apparatus recited in claim 32 wherein said recognition circuitry distinguishes between a said asset requiring protection and other items not requiring protection.

34. The detection apparatus recited in claim 32, said recognition circuitry comprising a processor and a database storage medium accessible to said processor.

35. The detection apparatus recited in claim 28, comprising recognition circuitry, wherein said recognition circuitry compares signals from said detector to signature information.

36. The detection apparatus recited in claim 35, wherein said recognition circuitry distinguishes between a said asset requiring protection and other items not requiring protection.

37. The detection apparatus recited in claim 35, said recognition circuitry comprising a processor and a database storage medium accessible to said processor.
